(19) United States
(12) Patent Application Publication
(10) Pub. No.: US 2014/0071213 A1
(43) Pub. Date: Mar. 13, 2014

(54) Phase Change Ink Compositions For Image Robustness

(71) Applicants: Salma Falah Toosi, Mississauga (CA); Mihaela Maria Birau, Mississauga (CA); C. Geoffrey Allen, Waterdown (CA); Christopher A. Wagner, Toronto (CA); Biby Esther Abraham, Mississauga (CA); Peter G. Odell, Mississauga (CA)

(72) Inventors: Salma Falah Toosi, Mississauga (CA); Mihaela Maria Birau, Mississauga (CA); C. Geoffrey Allen, Waterdown (CA); Christopher A. Wagner, Toronto (CA); Biby Esther Abraham, Mississauga (CA); Peter G. Odell, Mississauga (CA)

(73) Assignee: XEROX CORPORATION, Norwalk, CT (US)

(21) Appl. No.: 13/614,354

(22) Filed: Sep. 13, 2012

(51) Int. Cl. C09D 11/00

(52) U.S. Cl. CPC C09D 11/34
USPC 347/88; 524/590; 524/275; 524/230

(57) ABSTRACT

A phase change ink composition including a carrier; a colorant; and an acidic wax which is present in an amount of 0.1 to less than about 6 percent by weight based on the total weight of the phase change ink composition.

### TECHNICAL FIELD

Described herein are small molecule fatty acids for phase change or hot melt inks that may be used in a number of copying and printing devices. More particularly, described herein are phase change ink compositions including an acidic wax, in embodiments, stearic acid, and a colorant.

### BACKGROUND

Disclosed herein is a phase change ink composition comprising a carrier; a colorant; and an acidic wax, wherein the acidic wax is present in an amount of no more than about 6 percent by weight based on the total weight of the phase change ink composition.

In general, phase change inks (sometimes referred to as “hot melt inks”) are in the solid phase at ambient temperature, but exist in the liquid phase at the elevated operating temperature of an ink jet printing device. At the jet operating temperature, droplets of liquid ink are ejected from the printing device and, when the ink droplets contact the surface of the recording substrate, either directly or via an intermediate heated transfer belt or drum, they quickly solidify to form a predetermined pattern of solidified ink drops. Phase change inks have also been used in other printing technologies, such as gravure printing.

Phase change inks for color printing typically comprise a phase change ink carrier composition which is combined with a phase change ink compatible colorant. In a specific embodiment, a series of colored phase change inks can be formed by combining ink carrier compositions with compatible subtractive primary colorants. The subtractive primary colored phase change inks can comprise four component dyes, namely, cyan, magenta, yellow and black, although the inks are not limited to these four colors. These subtractive primary colored inks can be formed by using a single dye or a mixture of dyes. For example, magenta can be obtained by using a mixture of Solvent Red Dyes or a composite black can be obtained by mixing several dyes. U.S. Pat. No. 4,889,560, U.S. Pat. No. 4,889,761, and U.S. Pat. No. 5,372,852, the disclosures of each of which are totally incorporated herein by reference, teach that the subtractive primary colorants employed can comprise dyes from the classes of Color Index (C.I.) Solvent Dyes, Disperse Dyes, modified Acid and Direct Dyes, and Basic Dyes.

The colorants can also include pigments, as disclosed in, for example, U.S. Pat. No. 5,221,335, the disclosure of which is totally incorporated herein by reference.

Phase change inks have also been used for applications such as postal marking, industrial marking, and labeling.

Phase change inks are desirable for ink jet printers because they remain in a solid phase at room temperature during shipping, long term storage, and the like. In addition, the problems associated with nozzle clogging as a result of ink evaporation with liquid ink jet inks are largely eliminated, thereby improving the reliability of the ink jet printing. Further, in phase change ink jet printers wherein the ink droplets are applied directly onto the final recording substrate (for example, paper, transparency material, and the like), the droplets solidify immediately upon contact with the substrate, so that migration of ink along the printing medium is prevented and dot quality is improved.

Compositions suitable for use as phase change ink carrier compositions are known. Some representative examples of references disclosing such materials include U.S. Pat. No. 3,653,932, U.S. Pat. No. 4,390,369, U.S. Pat. No. 4,484,948, U.S. Pat. No. 4,684,956, U.S. Pat. No. 4,851,045, U.S. Pat. No. 4,889,560, U.S. Pat. No. 5,006,170, U.S. Pat. No. 5,151,120, U.S. Pat. No. 5,372,852, U.S. Pat. No. 5,496,879, European Patent Publication 0187352, European Patent Publication 0206286, German Patent Publication DE 4205636AL, German Patent Publication DE 4205713AL, and PCT Patent Application WO 94/04619, the disclosures of each of which are totally incorporated herein by reference. Suitable carrier materials can include paraffins, microcrystalline waxes, polyethylene waxes, ester waxes, fatty acids and other waxy materials, fatty amide containing materials, sulfonamide materials, resinous materials made from different natural sources (tall oil rosins and rosin esters, for example), and many synthetic resins, oligomers, polymers, and copolymers.

Ink jetting devices are known in the art, and thus extensive description of such devices is not required herein. As described in U.S. Pat. No. 6,547,380, which is hereby incorporated by reference herein in its entirety, ink jet printing systems generally are of two types: continuous stream and drop-on-demand. In continuous stream ink jet systems, ink is emitted in a continuous stream under pressure through at least one orifice or nozzle. The stream is perturbed, causing it to break up into droplets at a fixed distance from the orifice. At the break-up point, the droplets are charged in accordance with digital data signals and passed through an electrostatic field that adjusts the trajectory of each droplet in order to direct it to a gutter for recirculation or a specific location on a recording medium. In drop-on-demand systems, a droplet is expelled from an orifice directly to a position on a recording medium in accordance with digital data signals. A droplet is not formed or expelled unless it is to be placed on the recording medium.

There are at least three types of drop-on-demand ink jet systems. One type of drop-on-demand system is a piezoelectric device that has as its major components an ink filled channel or passageway having a nozzle on one end and a piezoelectric transducer near the other end to produce pressure pulses. Another type of drop-on-demand system is known as acoustic ink printing. As is known, an acoustic beam exerts a radiation pressure against objects upon which it impinges. Thus, when an acoustic beam impinges on a free surface (i.e., liquid/air interface) of a pool of liquid from beneath, the radiation pressure which it exerts against the surface of the pool may reach a sufficiently high level to release individual droplets of liquid from the pool, despite the restraining force of surface tension. Focusing the beam on or near the surface of the pool intensifies the radiation pressure it exerts for a given amount of input power. Still another type of drop-on-demand system is known as thermal ink jet, or bubble jet, and produces high velocity droplets. The major components of this type of drop-on-demand system are an ink filled channel having a nozzle on one end and a heat generating resistor near the nozzle. Printing signals representing digital information originate an electric current pulse in a resistive layer within each ink passageway near the orifice or nozzle, causing the ink vehicle (usually water) in the immediate vicinity to vaporize almost instantaneously and create a bubble. The ink at the orifice is forced out as a propelled droplet as the bubble expands.

In a typical design of a piezoelectric ink jet device utilizing phase change inks printing directly on a substrate or on an intermediate transfer member, such as the one described in U.S. Pat. No. 5,372,852, incorporated herein by reference, the image is applied by jetting appropriately colored inks during four to eighteen rotations (incremental movements) of a substrate (an image receiving member or intermediate transfer member) with respect to the ink jetting head, i.e., there is a small translation of the printhead with respect to the substrate in between each rotation. This approach simplifies the printhead design, and the small movements ensure good droplet registration. At the jet operating temperature, droplets of liquid ink are ejected from the printing device and, when the ink droplets contact the surface of the recording substrate, either directly or via an intermediate heated transfer belt or drum, they quickly solidify to form a predetermined pattern of solidified ink drops.

Thermal ink jet processes are well known and are described, for example, in U.S. Pat. Nos. 4,601,777, 4,251,824, 4,410,899, 4,412,224 and 4,532,530, the disclosures of each of which are hereby incorporated herein.

Ink jet printing processes may employ inks that are solid at room temperature and liquid at elevated temperatures. Such inks may be referred to as hot melt inks or phase change inks. For example, U.S. Pat. No. 4,490,731, which is hereby incorporated by reference herein, discloses an apparatus for dispensing solid ink for printing on a substrate such as paper. In thermal ink jet printing processes employing hot melt inks, the solid ink is melted by the heater in the printing apparatus and utilized (i.e., jetted) as a liquid in a manner similar to that of conventional thermal ink jet printing. Upon contact with the printing substrate, the molten ink solidifies rapidly, enabling the colorant to substantially remain on the surface of the substrate instead of being carried into the substrate (for example, paper) by capillary action, thereby enabling higher print density than is generally obtained with liquid inks. Advantages of a phase change ink in ink jet printing are thus elimination of potential spillage of the ink during handling, a wide range of print density and quality, minimal paper cockle or distortion, and enablement of indefinite periods of nonprinting without the danger of nozzle clogging, even without capping the nozzles.

Examples of the phase change inks herein are inks that include an ink vehicle that is solid at temperatures of about 23° C. to about 27° C., for example room temperature, and specifically are solid at temperatures below about 60° C. However, the inks change phase upon heating, and are in a molten state at jetting temperatures. Thus, the inks have a viscosity of from about 1 to about 20 centipoise (cp), for example from about 5 to about 15 cp or from about 8 to about 12 cp, at an elevated temperature suitable for ink jet printing, for example temperatures of from about 60° C. to about 150° C.

In this regard, the inks herein may be either low energy inks or high energy inks. Low energy inks are solid at a temperature below about 40° C. and have a viscosity of from about 1 to about 20 centipoise such as from about 5 to about 15 centipoise, for example from about 8 to about 12 cp, at a jetting temperature of from about 60° C. to about 100° C. such as about 80° C. to about 100° C., for example from about 90° C. to about 100° C. High energy inks are solid at a temperature below 40° C. and have a viscosity of from about 5 to about 15 centipoise at a jetting temperature of from about 100° C. to about 180° C., for example from 120° C. to about 160° C. or from about 125° C. to about 150° C.

Dye-based solid inks can be problematically soft and brittle. Dye-based solid inks can suffer from lack of scratch and fold resistance.

U.S. Pat. No. 4,118,244, which is hereby incorporated by reference herein in its entirety, describes in the Abstract thereof a paraffin wax composition of improved hardness comprising paraffin wax and an alkenyl succinic acid of alkenyl succinic anhydride.

U.S. Pat. No. 4,758,276, which is hereby incorporated by reference herein in its entirety, describes in the Abstract thereof a stearic acid-containing ink jet ink for use in an ink jet apparatus which features good print quality. The ink jet ink is discharged from the ink jet ink apparatus at elevated temperatures above ambient.

U.S. Pat. No. 6,022,910, which is hereby incorporated by reference herein in its entirety, describes in the Abstract thereof a hot-melt solid ink composition comprising at least one polyamide and at least one terpene resin. The terpene resin is present in an amount of from 0.5% by weight to 15% by weight based on the total weight of the ink composition. This hot-melt solid ink composition can be stable to heat upon recording using ink-jet recording apparatus where ink is heated to melt at a temperature higher than ordinary temperature to make a record, and has a superior transparency and a superior adhesion to printing mediums.

U.S. Pat. No. 5,350,446, which is hereby incorporated by reference herein in its entirety, describes in the Abstract thereof a hot melt ink jet ink for use in an impulse ink jet apparatus. The ink comprises a dispersed solid pigment which is formulated in a wax, or high molecular weight fatty acid or alcohol vehicle to form a hot melt ink which is solid at room temperature. The provision of such a pigment containing ink provides a high quality ink which is stable for long periods of time at relatively high temperatures. In the preferred embodiments, a dispersed graphite in a non-evaporative oil carrier, such as mineral oil, is formulated with candelilla wax, stearic acid and/or behenic acid.

While known compositions and processes are suitable for their intended purposes, the images currently produced by the phase change inks in many instances, exhibit poor scratch and fold resistance and poor image permanence. A need remains for improved phase change inks, and more specifically, dye-based phase change inks which exhibit improved image quality and robustness, that is resistance to scratch, crease or fold and abrasion with substantially no smear, and image permanence. Additionally, a need remains for phase change inks that print successfully on paper and transparency stock. Furthermore, there is a need for phase change inks that generate prints with good performance in automatic document feeders.

The appropriate components and process aspects of the each of the foregoing U.S. Patents and Patent Publications may be selected for the present disclosure in embodiments thereof. Further, throughout this application, various publications, patents, and published patent applications are referred to by an identifying citation. The disclosures of the publications, patents, and published patent applications referenced in this application are hereby incorporated by reference into the present disclosure to more fully describe the state of the art to which this invention pertains.

### SUMMARY

Described is a phase change ink composition comprising a carrier; a colorant; and an acidic wax, wherein the acidic wax which is present in an amount of 0.1 to less than about 6 percent by weight based on the total weight of the phase change ink composition.

Further described is a method comprising incorporating into an ink jet printing apparatus a phase change ink composition comprising a carrier; a colorant; and an acidic wax, wherein the acidic wax is present in an amount of 0.1 to less than about 6 percent by weight based on the total weight of the phase change ink composition to produce a phase change ink composition; melting the ink composition; and causing droplets of the melted ink to be ejected in an imagewise pattern onto a substrate.

Also described is an ink jet printer stick or pellet containing a phase change ink composition comprising a carrier; a colorant; and an acidic wax which is present in an amount of 0.1 to less than about 6 percent by weight based on the total weight of the phase change ink composition.

### DETAILED DESCRIPTION

Described is a phase change ink composition comprising a carrier; a colorant; and an acidic wax, wherein the acidic wax is present in an amount of up to about 6 percent by weight based on the total weight of the phase change ink composition.

The solid ink compositions herein possess great commercial value by providing printed images having improved image robustness. It has been discovered that the image robustness including scratch and fold resistance of prints prepared with the present solid ink is substantially increased by incorporating an acidic wax, in embodiments, small molecule waxes such as stearic acid.

In embodiments, the phase change ink compositions herein include an acidic wax in an amount of from about 0.1 to about 6 percent, or from about 0.1 to less than about 5 percent, or from about 0.1 to about 5 percent, or from about 0.3 to about 4 percent, or from about 0.5 to about 2 percent, or from about 0.5 to about 1 percent by weight acidic wax, based on the total weight of the phase change ink composition. In specific embodiments, the phase change ink compositions herein include an acidic wax in an amount of up to about 6 percent acidic wax, or less than about 6 percent acidic wax, or less than about 5 percent acidic wax, based on the total weight of the phase change ink composition.

In embodiments, the acidic wax is a linear organic acid having a carbon chain-length between about 8 and about 30 atoms. In certain embodiments, the acidic wax is selected from the group consisting of capryilic acid, capric acid, lauric acid, palmitic acid, myristic acid, stearic acid, eicosanoic acid, behenic acid, lignoceric acid, cerotic acid, montanic acid, melissic acid and mixtures and combinations thereof. In a specific embodiment, the acid wax is stearic acid.

In further embodiments, the acidic wax is a linear wax or a branched wax. In still further embodiments, the acidic wax is a saturated wax or an unsaturated wax.

In a specific embodiment, the phase change ink compositions herein contain stearic acid in an amount of less than about 5 percent stearic acid by weight to dye-based solid ink which significantly improves the performance of the ink with respect to scratch and fold resistance. For example, a print made from dye-based cyan ink containing 5 percent by weight stearic acid as provided herein loss almost 6 times less ink under the scratched area than a print prepared with a comparative ink that did not contain stearic acid. Further, inclusion of 5 percent by weight stearic acid to dye-based cyan ink provided a fold result wherein twice less an amount of ink was removed after a folding test compared to a print prepared with a comparative ink without stearic acid.

It has been unexpectedly found that incorporation in dye-based phase change ink of 5 percent by weight stearic acid, or less than 5 percent by weight stearic acid, or in a specific embodiments 4.8 percent by weight stearic acid provides improved image robustness to images printed therewith.

Stearic acid is an example of a fatty acid. A fatty acid is a saturated or unsaturated carboxylic acid with a long aliphatic tail. Most naturally occurring fatty acids have a chain of an even number of carbon atoms, from 4 to 28. Stearic acid is a saturated linear acid having the formula

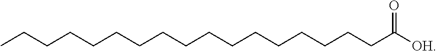 [SMILES: CCCCCCCCCCCCCCCCCC(=O)O]

Stearic acids are chiefly produced from saponified and distilled animal fatty acids. These fatty acids are usually composed of approximately 60% liquid and 40% solid acids. The bulk of the liquid acids are separated from the solid acids by any suitable means such as by hydraulic pressing.

In embodiments, the fatty acid, in specific embodiments the stearic acid, interacts with the first wax in the phase change in compositions, in embodiments the first wax being polyethylene wax, making the wax hard. In embodiment, stearic acid provides the phase change ink composition herein with good adhesion to a substrate, in embodiments, with good adhesion to paper.

In embodiments, stearic acid can be present in the phase change ink compositions herein in an amount of up to about 6 percent, or up to 5 percent, by weight based on the total weight of the phase change ink composition. In further embodiments, the stearic acid can be present in the dye-based phase change ink compositions herein in an amount of less than 6 percent, or less than 5 percent, by weight based on the total weight of the phase change ink composition. In further embodiments, the fatty acid, in embodiments, stearic acid, can be present in the phase change ink compositions herein in an amount of 4.8 percent by weight based on the total weight of the phase change ink composition.

The phase change ink compositions herein can include any suitable ink carrier or vehicle, such as paraffins, microcrystalline waxes, polyethylene waxes, ester waxes, amides, fatty acids and other waxy materials, fatty amide containing materials, sulfonamide materials, resinous materials made from different natural sources (tall oil rosins and rosin esters, for example), and many synthetic resins, oligomers, polymers, and copolymers such as further discussed below.

In embodiments, the phase change ink compositions herein include a first wax (which is a wax other than the acidic wax) which is, in embodiments a polyaklyene wax. In further embodiments, the first wax is a polymethylene wax, a polyethylene wax, or a mixture of combination thereof.

In certain embodiments, the phase change ink compositions herein include a biodegradable wax. In embodiments, the biodegradable wax is a biodegradable polyethylene wax. For example, the wax can be a compostable/biodegradable polyethylene wax such as are available from companies such as The International Group, Inc. and Sasol Wax.

In embodiments, the dye-based phase change ink compositions herein further comprises a low melting wax. In embodiments, the low melting wax is a polyalkylene wax, a functional wax, or a combination thereof. The term “functional wax” is known to one of skill in the art and can mean herein any suitable functional wax, in embodiments, including, but not limited to, a wax with polar groups, for example, alcohols, amides, esters, urethanes, etc. As used herein, the term “low melting wax” includes any suitable low melting wax, including, in embodiments, a wax having a melting point of less than about 120° C.

Examples of suitable amides include, for example, diamides, triamides, tetra-amides, cyclic amides and the like. Suitable triamides include, for example, those disclosed in U.S. Pat. No. 6,860,930, the entire disclosure of which is incorporated herein by reference. Suitable other amides, such as fatty amides including monoamides, tetra-amides, and mixtures thereof, are disclosed in, for example, U.S. Pat. Nos. 4,889,560, 4,889,761, 5,194,638, 4,830,671, 6,174,937, 5,372,852, 5,597,856, and 6,174,937, and British Patent No. GB 2 238 792, the entire disclosures of each are incorporated herein by reference.

The ink jet vehicle or carrier can be present in the phase change ink composition in any suitable or desired amount. In embodiments, the carrier is present in the dye-based phase change ink composition in an amount of from about 25 percent to about 65 percent by weight based on the total weight of the dye-based phase change ink composition. In embodiments, the carrier is a low melting wax present in the dye-based phase change ink composition in an amount of from about 25% to less than about 65% by weight based on the total weight of the ink carrier.

Other suitable carrier materials that can be used in the phase change ink composition include isocyanate-derived resins and waxes, such as urethane isocyanate-derived materials, urea isocyanate-derived materials, urethane/urea isocyanate-derived materials, mixtures thereof, and the like. Further information on isocyanate-derived carrier materials is disclosed in, for example, U.S. Pat. Nos. 5,750,604, 5,780,528, 5,782,966, 5,783,658, 5,827,918, 5,830,942, 5,919,839, 6,255,432, and 6,309,453, British Patents Nos. GB 2 294 939, GB 2 305 928, GB 2 305 670, and GB 2 290 793, and PCT Publications WO 94/14902, WO 97/12003, WO 97/13816, WO 96/14364, WO 97/33943, and WO 95/04760, the entire disclosures of each of which are incorporated herein by reference. In embodiments, the phase change ink composition can contain a mixture of one or more amides and one or more isocyanate-derived materials.

Further examples of suitable ink vehicles include ethylene/propylene copolymers, such as those available from Baker Petrolite. Commercial examples of such copolymers include, for example, Petrolite CP-7 (Mn=650), Petrolite CP-11 (Mn=1,100, Petrolite CP-12 (Mn=1,200) and the like. The copolymers may have, for example, a melting point of from about 70° C. to about 150° C., such as from about 80° C. to about 130° C. or from about 90° C. to about 120° C. and a molecular weight range (Mn) of from about 500 to about 4,000.

Another type of ink vehicle may be n-paraffinic, branched paraffinic, and/or naphthenic hydrocarbons, typically with from about 5 to about 100, such as from about 20 to about 80 or from about 30 to about 60 carbon atoms, generally prepared by the refinement of naturally occurring hydrocarbons, such as BE SQUARE 185 and BE SQUARE 195, with molecular weights (Mn) of from about 100 to about 5,000, such as from about 250 to about 1,000 or from about 500 to about 800, for example such as available from Baker Petrolite.

Highly branched hydrocarbons, typically prepared by olefin polymerization, such as the VYBAR materials available from Baker Petrolite, including VYBAR 253 (Mn=520), VYBAR 5013 (Mn=420), and the like, may also be used. In addition, the ink vehicle may be an ethoxylated alcohol, such as available from Baker Petrolite and of the general formula

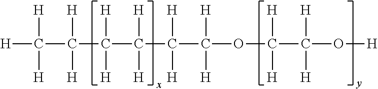

wherein x is an integer of from about 1 to about 50, such as from about 5 to about 40 or from about 11 to about 24 and y is an integer of from about 1 to about 70, such as from about 1 to about 50 or from about 1 to about 40. The materials may have a melting point of from about 60° C. to about 150° C., such as from about 70° C. to about 120° C. or from about 80° C. to about 110° C. and a molecular weight (Mn) range of from about 100 to about 5,000, such as from about 500 to about 3,000 or from about 500 to about 2,500. Commercial examples include UNITHOX 420 (Mn=560), UNITHOX 450 (Mn=900), UNITHOX 480 (Mn=2,250), UNITHOX 520 (Mn=700), UNITHOX 550 (Mn=1,100), UNITHOX 720 (Mn=875), UNITHOX 750 (Mn=1,400), and the like.

As an additional example, the ink vehicle may be made of fatty amides, such as monoamides, tetra-amides, mixtures thereof, and the like, for example such as described in U.S. Pat. No. 6,858,070, which is hereby incorporated herein by reference. Suitable monoamides may have a melting point of at least about 50° C., for example from about 50° C. to about 150° C., although the melting point can be outside these ranges. Specific examples of suitable monoamides include, for example, primary monoamides and secondary monoamides. Stearamide, such as KEMAMIDE S available from Witco Chemical Company and CRODAMIDE S available from Croda, behenamide/arachidamide, such as KEMAMIDE B available from Witco and CRODAMIDE BR available from Croda, oleamide, such as KEMAMIDE U available from Witco and CRODAMIDE OR available from Croda, technical grade oleamide, such as KEMAMIDE O available from Witco, CRODAMIDE O available from Croda, and UNISLIP 1753 available from Uniqema, and erucamide such as KEMAMIDE E available from Witco and CRODAMIDE ER available from Croda, are some examples of suitable primary amides. Behenyl behenamide, such as KEMAMIDE EX666 available from Witco, stearyl stearamide, such as KEMAMIDE S-180 and KEMAMIDE EX-672 available from Witco, stearyl erucamide, such as KEMAMIDE E-180 available from Witco and CRODAMIDE 212 available from Croda, erucyl erucamide, such as KEMAMIDE E-221 available from Witco, oleyl palmitamide, such as KEMAMIDE P-181 available from Witco and CRODAMIDE 203 available from Croda, and erucyl stearamide, such as KEMAMIDE S-221 available from Witco, are some examples of suitable secondary amides. Additional suitable amide materials include KEMAMIDE W40 (N,N′-ethylenebisstearamide), KEMAMIDE P181 (oleyl palmitamide), KEMAMIDE W45 (N,N′-thylenebisstearamide), and KEMAMIDE W20 (N,N′-ethylenebisoleamide). In embodiments, the phase change ink composition can comprise stearyl stearamide, triamide, or mixtures thereof.

High molecular weight linear alcohols, such as those available from Baker Petrolite and of the general formula

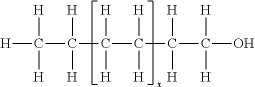

wherein x is an integer of from about 1 to about 50, such as from about 5 to about 35 or from about 11 to about 23, may also be used as the ink vehicle. These materials may have a melting point of from about 50° C. to about 150° C., such as from about 70° C. to about 120° C. or from about 75° C. to about 110° C., and a molecular weight (Mn) range of from about 100 to about 5,000, such as from about 200 to about 2,500 or from about 300 to about 1,500. Commercial examples include the UNILIN materials such as UNILIN 425 (Mn=460), UNILIN 550 (Mn=550), UNILIN 700 (Mn=700), and distilled alcohols, the viscosity of which at the jetting temperature in one embodiment can be from about 5 to about 50% higher than the non-distilled alcohol.

A still further example includes hydrocarbon-based waxes, such as the homopolymers of polyethylene available from Baker Petrolite and of the general formula

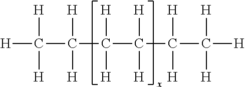

wherein x is an integer of from about 1 to about 200, such as from about 5 to about 150 or from about 12 to about 105. These materials may have a melting point of from about 60° C. to about 150° C., such as from about 70° C. to about 140° C. or from about 80° C. to about 130° C. and a molecular weight (Mn) of from about 100 to about 5,000, such as from about 200 to about 4,000 or from about 400 to about 3,000. Example waxes include PW400 (Mn about 400), distilled PW400, in one embodiment having a viscosity of about 10% to about 100% higher than the viscosity of the undistilled POLYWAX® 400 at about 110° C., POLYWAX 500 (Mn about 500), distilled POLYWAX® 500, in one embodiment having a viscosity of about 10% to about 100% higher than the viscosity of the undistilled POLYWAX® 500 at about 110° C., POLYWAX 655 (Mn about 655), distilled POLYWAX® 655, in one embodiment having a viscosity of about 10% to about 50% lower than the viscosity of the undistilled POLYWAX® 655 at about 110° C., and in yet another embodiment having a viscosity of about 10% to about 50% higher than the viscosity of the undistilled POLYWAX® 655 at about 110° C. POLYWAX 850 (Mn about 850), POLYWAX 1000 (Mn about 1,000), and the like.

Another example includes modified maleic anhydride hydrocarbon adducts of polyolefins prepared by graft copolymerization, such as those available from Baker Petrolite and of the general formulas

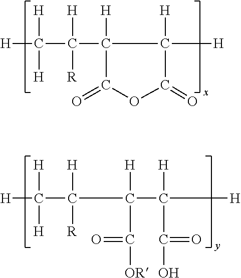

wherein R is an alkyl group with from about 1 to about 50, such as from about 5 to about 35 or from about 6 to about 28 carbon atoms, R′ is an ethyl group, a propyl group, an isopropyl group, a butyl group, an isobutyl group, or an alkyl group with from about 5 to about 500, such as from about 10 to about 300 or from about 20 to about 200 carbon atoms, x is an integer of from about 9 to about 13, and y is an integer of from about 1 to about 50, such as from about 5 to about 25 or from about 9 to about 13, and having melting points of from about 50° C. to about 150° C., such as from about 60° C. to about 120° C. or from about 70° C. to about 100° C.; and those available from Baker Petrolite and of the general formula

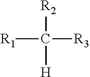

wherein R₁ and R₃ are hydrocarbon groups and R₂ is either of one of the general formulas

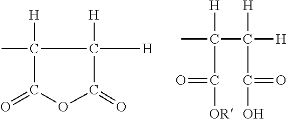

or a mixture thereof, wherein R′ is an isopropyl group, which materials may have melting points of from about 70° C. to about 150° C., such as from about 80° C. to about 130° C. or from about 90° C. to about 125° C., with examples of modified maleic anhydride copolymers including CERAMER 67 (Mn=655, Mw/Mn=1.1), CERAMER 1608 (Mn=700, Mw/Mn=1.7), and the like.

Additional examples of suitable ink vehicles for the phase change inks include rosin esters; polyamides; dimer acid amides; fatty acid amides, including ARAMID C; epoxy resins, such as EPOTUF 37001, available from Riechold Chemical Company; fluid paraffin waxes; fluid microcrystalline waxes; Fischer-Tropsch waxes; polyvinyl alcohol resins; polyols; cellulose esters; cellulose ethers; polyvinyl pyridine resins; fatty acids; fatty acid esters; poly sulfonamides, including KETJENFLEX MH and KETJENFLEX MS80; benzoate esters, such as BENZOFLEX 5552, available from Velsicol Chemical Company; phthalate plasticizers; citrate plasticizers; maleate plasticizers; sulfones, such as diphenyl sulfone, n-decyl sulfone, n-arnyl sulfone, chlorophenyl methyl sulfone; polyvinyl pyrrolidinone copolymers; polyvinyl pyrrolidone/polyvinyl acetate copolymers; novolac resins, such as DUREZ 12 686, available from Occidental Chemical Company; and natural product waxes, such as beeswax, monton wax, candelilla wax, GILSONITE (American Gilsonite Company), and the like; mixtures of linear primary alcohols with linear long chain amides or fatty acid amides, such as those with from about 6 to about 24 carbon atoms, including PARICIN 9 (propylene glycol monohydroxystearate), PARICIN 13 (glycerol monohydroxystearate), PARICIN 15 (ethylene glycol monohydroxystearate), PARICIN 220 (N(2-hydroxyethyl)-12-hydroxystearamide), PARICIN 285 (N,N′-ethylene-bis-12-hydroxystearamide), FLEXRICIN 185 (N,N′-ethylene-bis-ricinoleamide), and the like. Further, linear long chain sulfones with from about 4 to about 16 carbon atoms, such as n-propyl sulfone, n-pentyl sulfone, n-hexyl sulfone, n-heptyl sulfone, n-octyl sulfone, n-nonyl sulfone, n-decyl sulfone, n-undecyl sulfone, n-dodecyl sulfone, n-tridecyl sulfone, n-tetradecyl sulfone, n-pentadecyl sulfone, n-hexadecyl sulfone, and the like, are suitable ink vehicle materials.

In addition, the ink vehicles described in U.S. Pat. No. 6,906,118, which is incorporated herein by reference, may also be used. The ink vehicle may contain a branched triamide such as those described in U.S. Pat. No. 6,860,930, the disclosure of which is also incorporated by reference herein,

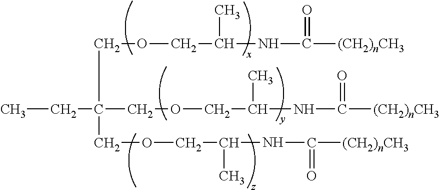

wherein n has an average value of from about 34 equal to or less than 40, where x, y and z can each be zero or an integer, and wherein the sum of x, y, and z is from about 5 and equal to or less than 6.

Optionally, a plasticizer, which can be either a solid or liquid plasticizer, such as benzyl phthalates, triaryl phosphate esters, pentaerythritol tetrabenzoate, dialkyl adipate, dialkyl phthalates, dialkyl sebacate, alkyl benzyl phthalates, ethylene glycol monostearate, glycerol monostearate, propylene glycol monostearate, dicyclohexyl phthalate, diphenyl isophthalate, triphenyl phosphate, dimethyl isophthalate, and mixtures thereof, or the like can also be included in the ink carrier. The plasticizer is present in the ink carrier in any desired or effective amount, such as from about 0.05% by weight of the ink carrier. Examples of suitable plasticizers include SANTICIZER® 278, SANTICIZER® 154, SANTICIZER®160, SANTICIZER® 261 (commercially available from Monsanto), and the like or mixtures thereof.

A hindered amine antioxidant can optionally be present in the ink in any desired or effective amount, such as from about 0.001 percent to about 0.50 percent by weight of the total ink composition.

Examples of suitable hindered amine antioxidants include those of general formula

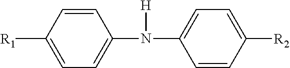

wherein R₁ and R₂ each, independently of the other, can be a hydrogen atom or an alkyl group, including linear, branched, saturated, unsaturated, cyclic, substituted, and unsubstituted alkyl groups, and wherein hetero atoms, such as oxygen, nitrogen, sulfur, silicon, phosphorus, boron, either may or may not be present in the alkyl group, in one embodiment with at least 1 carbon atom, if substituted, substitutions can be alkyl or phenyl.

Specific examples of suitable hindered amine antioxidants include the following antioxidants commercially available from Crompton; NAUGUARD® 445 where R₁=R₂=C(CH₃)₂Ph, NAUGUARD® 635 where R₁=R₂=—CH(CH₃)Ph, NAUGUARD® PS-30 where R₁=C₄ or C₈, R₂=C₄ or C₈ and the like.

A hindered phenol antioxidant can also be provided. In one embodiment the hindered phenol is present in a relatively high concentration. A high concentration of hindered phenol antioxidant maximizes long term thermal stability by delaying the onset of the oxidation itself. The hindered phenol antioxidant is present in the ink in any desired or effective amount, in embodiments from about 0.01% to about 4.0% by weight of the total ink composition. Specific examples of suitable hindered phenol antioxidants include ETHANOX® 330, ETHANOX® 310, ETHANOX® 314, ETHANOX® 376 (commercially available from Albemarle) and the like. Also commercially available from BASF SE are IRGANOX® 1010, IRGANOX® 1035, IRGANOX®1076, IRGANOX® 1330 and the like. Mixtures of two or more of these hindered phenol antioxidants can also be employed.

A rosin ester resin, mixtures thereof, or the like can also be included in the dye-based phase change ink composition. The rosin ester resin is present in any desired or effective amount, in embodiments from 0.5% to about 20% by weight of the total ink composition. Examples of suitable rosin ester resins include Pinecrystal KE-100 (commercially available from Arakawa), and the like.

The phase change ink composition can include ink carrier, in embodiments comprising wax and other optional carrier components, in any desired or effective amount, in one embodiment in an amount of at least about 50% by weight of the ink, in another embodiment of at least about 70% by weight of the ink, and in yet another embodiment of at least about 90% by weight of the ink, and in one embodiment equal to or less than about 99% by weight of the ink, in another embodiment equal to or less than about 98% by weight of the ink, and in yet another embodiment equal to or less than about 95% by weight of the ink, although the amount can be outside of these ranges. In certain embodiments, in an amount of from about 25% to about 65% by total weight of the phase change ink composition.

In one specific embodiment, the ink carrier has a melting point of less than about 110° C., and in another embodiment of less than about 100° C., although the melting point of the ink carrier can be outside of these ranges.

The phase change ink compositions also contain a colorant comprising a pigment, a dye, or a combination thereof. In specific embodiments, the colorant is a dye. The dye-based phase change ink compositions can be used in combination with conventional phase change ink colorant materials, such as Color Index (C.I.) Solvent Dyes, Disperse Dyes, modified Acid and Direct Dyes, Basic Dyes, Sulphur Dyes, Vat Dyes, and the like. Examples of suitable dyes include Orasol Red 363 (BASF The Chemical Company); Aizen Spilon Red C-BH (Hodogaya Chemical); ORASOL Yellow 2GLN, ORASOL Yellow 2RLN, ORASOL Orange G, ORASOL Brown 2RL, ORASOL Red 2B, ORASOL Blue BL, ORASOL Blue GN, ORASOL Black RLI, Yellow 3G, Orange R 01, Blue B 01 (BASF The Chemical Company); MORPLAS Red 32, MORPLAS Red 46, MORPLAS Red 60, MORPLAS Red 61, MORPLAS Red 111, MORPLAS Red 135, MORPLAS Red 179, MORPLAS Red 24, MORPLAS Red 26, MORPLAS Red 430, MORPLAS Red 5B, MORPLAS Red RO, MORPLAS Red LB, MORPLAS Magenta 36, MORPLAS FL Red 5B, MORPLAS Red 149, MORPLAS Yellow 9, MORPLAS Yellow 16, MORPLAS Yellow 33, MORPLAS Yellow 56, MORPLAS Yellow 72, MORPLAS Yellow 3G, MORPLAS Yellow 8G, MORPLAS Yellow 821, MORPLAS Yellow 825, MORPLAS Yellow GS, MORPLAS Yellow TG, MORPLAS FL Yellow G, MORPLAS FL Yellow 44, MORPLAS FL Yellow C-6, MORPLAS FL Yellow 3G, MORPLAS Orange 60, MORPLAS Orange 63, MORPLAS Orange Y, MORPLAS Amber, MORPLAS Blue 20, MORPLAS Blue 1003, MORPLAS Blue B, MORPLAS ERO Blue, MORPLAS Blue E, MORPLAS Blue 2B, MORPLAS Blue 2R, MORPLAS Blue N, MORPLAS Green 3, MORPLAS Green 5, MORPLAS Violet 14, MORPLAS Violet 3B, MORPLAS Violet R, MORPLAS Purple KI, MORPLAS Black N, NAVIPON Yellow R, NAVIPON Yellow GL, NAVIPON Yellow 2RL, NAVIPON Orange RL, NAVIPON Orange RE, NAVIPON Orange G, NAVIPON Orange R, NAVIPON Fire Red GLS, NAVIPON Fire Red G, NAVIPON Fire BL, NAVIPON Red 2BL, NAVIPON Pink SBLG, NAVIPON Blue 2GLN, NAVIPON Blue 2GN, NAVIPON Blue 3R, NAVIPON Brown 2RL, NAVIPON Black RL, NAVIPON Black RE, MORFAST Yellow 101, MORFAST Blue 100, MORFAST Yellow 102, MORFAST Blue 105, MORFAST Brown 100, MORFAST Blue 106, MORFAST Red 101, MORFAST Green 101, MORFAST Red 102, MORFAST Black 101, MORFAST Red 105, MORFAST Black 108, MORFAST Red 106, MORFAST Black 112, MORFAST Red 109, MORFAST Black DC, MORFAST Red 111, MORFAST Violet 101 (Sunbelt Corporation); VALIFAST Yellow 3150, VALIFAST Yellow 4122, VALIFAST Orange 3208, VALIFAST RED 3304, VALIFAST Red 3312, VALIFAST Blue 2606, VALIFAST Blue 2620, VALIFAST Blue 2670, VALIFAST Black 3808, 3G, Oil Yellow GGS, Oil Yellow 105, Oil Yellow 107, Oil Yellow 129, Oil Orange PS, Oil Orange 201, Oil Red RR, Oil Red 5B, Oil Red OG, Oil Red XO, Oil Scarlet 308, Oil Scarlet 318, Oil Pink 312, Orient Violet MVB-3, Oil Brown BB, Oil Brown BF, Oil Brown 416, Oil Green 502, Orient Green 1, Oil Blue 613, Oil Blue 2N, Oil Blue 650, Oil Black HZ, Oil Black 860 (Orient Corporation of America); Savinyl Black RLS (Sandoz); Dermacarbon 2GT (Sandoz); Pyrazol Black BG (ICI); MORFAST Black Conc. A (Morton-Thiokol); Diaazol Black RN Quad (ICI); Orasol Blue GN (BASF); Savinyl Blue GLS (Sandoz); Luxol Blue MBSN (Morton-Thiokol); Sevron Blue 5GMF (ICI); Basacid Blue 750 (BASF), Neozapon Black X51 [C.I. Solvent Black, C.I. 12195] (BASF), Sudan Blue 670 [C.I. 61554] (BASF), Sudan Yellow 146 [C.I. 12700] (BASF), Sudan Red 462 [C.I. 26050] (BASF), Intratherm Yellow 346 commercially available from Crompton and Knowles, C.I. Disperse Yellow 238, Neptune Red Base NB543 (BASF, C.I. Solvent Red 49), Neopen Blue FF-4012 commercially available from BASF, Lampronol Black BR commercially available from ICI (C.I. Solvent Black 35), Morton MORPLAS Magenta 36 (C.I. Solvent Red 172), metal phthalocyanine colorants such as those disclosed in U.S. Pat. No. 6,221,137, the disclosure of which is totally incorporated herein by reference, and the like. Polymeric dyes can also be used, such as those disclosed in, for example, U.S. Pat. No. 5,621,022 and U.S. Pat. No. 5,231,135, the disclosures of each of which are totally incorporated herein by reference, and commercially available from, for example, Milliken & Company as Milliken Ink Yellow 12, Milliken Ink Blue 92, Milliken Ink Red 357, Milliken Ink Yellow 1800, Milliken Ink Black 8915-67, uncut Reactant Orange X-38, uncut Reactant Blue X-17, Solvent Yellow 162, Acid Red 52, Solvent Blue 44, and uncut Reactant Violet X-80. In a specific embodiment, the colorant is a cyan dye.

The colorant is present in the phase change ink in any desired or effective amount to obtain the desired color or hue, in embodiments from about 0.1 to about 15 percent by weight based on the total weight of the phase change ink composition.

In embodiments, the acid wax is present in the ink carrier during the incorporation of a colorant wherein the colorant is a dye or a pigment. In other embodiments, the acid wax is added after the formation of a first ink containing a colorant, wherein the colorant is a dye or a pigment, to form a second ink. The acid wax in embodiments can be added and co-melted with one of the ink carrier components, some of the ink carrier components, most of the ink carrier components or all of the ink carrier components used to form the ink. In embodiments, the acid wax can be added to form the ink in any suitable manner including mixing such as by stirring, such as by high shear mixing, with or without milling media, such as by milling including by ball milling and by attrition or by any other suitable method. In embodiments, the acid wax can be added as a powder or a molten liquid to form the ink.

The phase change ink compositions disclosed herein in one embodiment have melting points in one embodiment equal to or less than about 130° C., in another embodiment equal to or less than about 120° C., in a further embodiment equal to or less than about 110° C., and in still another embodiment equal to or less than about 100° C., although the melting point can be outside of these ranges.

The phase change ink compositions prepared by the process disclosed herein generally have melt viscosities, at the jetting temperature which can be equal to or less than about 145° C., in one embodiment equal to or less than about 130° C., and in another embodiment equal to or less than about 120° C., in a further embodiment equal to or less than about 110° C., and in yet another embodiment equal to or less than about 80° C., although the jetting temperature can be outside of these ranges, which are in one embodiment equal to or less than about 30 centipoise (cps), in another embodiment equal to or less than about 25 cps, and in yet a further embodiment equal to or less than about 20 cps, and in another embodiment no less than about 2 cps, in a further embodiment no less than about 3 cps, and in yet a further embodiment no less than about 4 cps, although the melt viscosity can be outside of these ranges.

In certain embodiments, the phase change ink composition herein has a jetting temperature of from about 100° C. to about 130° C.

In embodiments, the phase change ink composition herein has a viscosity of about 9 to about 12 centipoise at 110° C. In certain embodiments, the phase change ink composition herein has a viscosity of about 10 centipoise at 110° C.

In embodiments, the phase change ink composition herein produces an image printed with the phase change ink composition which provides a fold result of less than about 1% removed by fold; wherein the fold result is an ink are removed by a fold test divided by a fixed test pattern area of the print (containing a known and definite amount of printed pixels of ink on the paper) multiplied by 100 percent.

In embodiments, the phase change ink composition herein produces an image printed with the phase change ink composition which provides a scratch result of less than about 4% removed by scratch; wherein the scratch result is an ink area removed from the scratch/gouge finger divided by the fixed test pattern area of the print (containing a known and definite amount of printed pixels of ink on the paper) multiplied by 100 percent.

The phase ink compositions of the present disclosure can be prepared by any desired or suitable method. In embodiments, a method for preparing a phase change ink composition comprises combining a carrier; a dye; and stearic acid which is present in an amount of up to 5 percent by weight based on the total weight of the phase change ink composition to produce a phase change ink composition. For example, the ink ingredients can be mixed together, followed by heating, to a temperature of at least about 100° C. to no more than about 140° C., although the temperature can be outside of this range, and stirring until a homogeneous ink composition is obtained, followed by cooling the ink to ambient temperature (typically from about 20 to about 25° C.). The inks of the present disclosure are solid at ambient temperature. In a specific embodiment, during the formation process, the inks in their molten state are poured into molds and then allowed to cool and solidify to form ink sticks. In embodiments, an ink jet printer stick or pellet herein contains a phase change ink composition comprising a carrier; a colorant; and an acidic wax which is present in an amount of 0.1 to less than about 6 percent by weight based on the total weight of the phase change ink composition.

The inks disclosed herein can be employed in apparatus for direct printing ink jet processes and in indirect (offset) printing ink jet applications. Another embodiment is directed to a process which comprises incorporating an ink as disclosed herein into an ink jet printing apparatus, melting the ink, and causing droplets of the melted ink to be ejected in an imagewise pattern onto a recording substrate. A direct printing process is also disclosed in, for example, U.S. Pat. No. 5,195,430, the disclosure of which is totally incorporated herein by reference. The inks prepared as disclosed herein can be employed in apparatus for indirect (offset) printing ink jet applications. Another embodiment is directed to a process which comprises incorporating an ink prepared as disclosed herein into an ink jet printing apparatus, melting the ink, causing droplets of the melted ink to be ejected in an imagewise pattern onto an intermediate transfer member, and transferring the ink in the imagewise pattern from the intermediate transfer member to a final recording substrate. In a specific embodiment, the intermediate transfer member is heated to a temperature above that of the final recording sheet and below that of the melted ink in the printing apparatus. An offset or indirect printing process is also disclosed in, for example, U.S. Pat. No. 5,389,958, the disclosure of which is totally incorporated herein by reference. In one specific embodiment, the printing apparatus employs a piezoelectric printing process wherein droplets of the ink are caused to be ejected in imagewise pattern by oscillations of piezoelectric vibrating elements.

Any suitable substrate or recording sheet can be employed, including plain papers such as XEROX® 4024 papers, XEROX® Image Series papers, Courtland 4024 DP paper, ruled notebook paper, bond paper, silica coated papers such as Sharp Company silica coated paper, JuJo paper, Hammermill Laserprint Paper, and the like, transparency materials, fabrics, textile products, plastics, polymeric films, inorganic substrates such as metals and wood, and the like.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

The ink materials used in the examples are presented in Table 1.

TABLE 1

| Ink Base Materials | Details |
|---|---|
| Polymethylene wax, | A fractionated polymethylene wax available |
| Wax A | from The International Group, Inc. |
| Polyethylene wax, | A fractionated biodegradable polyethylene |
| Wax B | wax available from The International Group, |
| | Inc. |
| Triamide wax | As prepared in Example 2 of U.S. Pat. No. |
| | 6,860,930 |
| KEMAMIDE ® S-180 | Stearyl stearamide available from Chemtura |
| | Corporation |
| KE-100 | an ester of tetrahydroabietic acid and glycerol |
| | available from Arakawa Industries |
| Urethane resin | As prepared in example 4 of U.S. Pat. No. |
| | 6,309,453 |
| NAUGARD ® 445 | Antioxidant available from Chemtura |
| | Corporation |
| Cyan dye | As prepared in Example VII of U.S. Pat. No. |
| | 6,472,523 |
| Cyan pigment | A C.I. Pigment Blue 15:3 obtained from |
| | Clariant GmbH |

Cyan dye as prepared in Example VII of U.S. Pat. No. 6,472,523, which is hereby incorporated by reference herein in its entirety, was prepared as follows. A mixture of 4-(3-pentadecyl)phenoxyphthalonitrile (25.8 grams, 0.060 mole), copper(II) acetate dehydrate (3.0 grams, 0.015 mole), and ammonium acetate (9.2 grams, 0.12 mole) in 100 milliliters of NMP was stirred and heated to 120° C. Slow gas evolution was observed, and after 5 minutes, a deep, dark blue color developed. After 30 minutes at 120° C., the reaction mixture was heated to 180° C. for 1 hour. NMP (50 milliliters) was then added and the mixture was stirred and reheated to 180° C., followed by cooling with stiffing to room temperature. The product was then filtered and the solid was washed in the filter funnel with 2×100 milliliter portion of DMF. It was then stirred in 200 milliliters of acetone at 50° C. and subsequently filtered. This acetone treatment was repeated, and the solid was dried at 60° C. overnight to give the product as a coarse power (19.9 grams, 74 percent). The spectral strength of this material was 1.27×10⁵ A*ml/g, which is indicative of high purity (i.e., about 98 percent purity).

### Comparative Example 1

An ink was prepared as follows. Into a 500 milliliter beaker were introduced 52.94 parts polymethylene wax, 14.82 parts triamide wax, 14.25 parts KEMAMIDE® S180, 13.42 parts KE-100 resin, 0.9 parts urethane resin and 0.16 parts NAUGARD® 445. The beaker was placed in an oven at 130° C. until all materials were molten then transferred to a hot plate and allowed to stir for 1 hour at 120° C. To this were slowly added, 3.51 parts of a cyan dye as prepared in Example VII of U.S. Pat. No. 6,472,523. The resultant ink was filtered through a 5 μm stainless steel mesh.

### Example 2

A cyan ink was prepared as follows. A molten and thoroughly mixed blend consisting of 45.2 parts polymethylene wax, 14.2 parts triamide wax, 14.2 parts KE-100 resin, 15.7 parts KEMAMIDE® S180, 2.2 parts urethane resin, 0.2 parts NAUGARD® 445 and 4.8 parts stearic acid (available from Sigma-Aldrich Co. LLC) were placed into a 600 milliliter beaker on top of a hot plate and allowed to stir for 1 hour at 120° C. To this were slowly added, 3.5 parts of a cyan dye as prepared in Example VII of U.S. Pat. No. 6,472,523. The resultant ink was stirred for 2.5 hours at 120° C. and then was filtered through a 5 μm stainless steel mesh and a 1 μm paper filter, respectively.

### Example 3

A cyan ink with biodegradable wax was prepared as follows. A molten and thoroughly mixed blend consisting of 45.2 parts of a biodegradable polyethylene wax, 14.2 parts triamide wax, 14.2 parts KE-100 resin, 15.7 parts KEMAMIDE® S180, 2.2 parts urethane resin, 0.2 parts NAUGARD® 445, and 4.8 parts stearic acid (available from Sigma-Aldrich Co. LLC) were placed into a 600 milliliter beaker on top of a hot plate and allowed to stir for 1 hour at about 105° C. To this were slowly added, 3.5 parts of a cyan dye as prepared in Example VII of U.S. Pat. No. 6,472,523. The resultant ink was stirred for 2.5 hours at 120° C. and then was filtered through a 5 μm stainless steel mesh and 1 μm paper filter, respectively.

### Comparative Example 4

A cyan ink was prepared as follows. A molten and thoroughly mixed blend consisting of 40.0 parts polymethylene wax, 14.2 parts triamide wax, 14.2 parts KE-100 resin, 15.7 parts KEMAMIDE® S180, 2.2 parts urethane resin, 0.2 parts NAUGARD® 445, and 10 parts stearic acid (available from Sigma-Aldrich Co. LLC) were placed into a 600 milliliter beaker on top of a hot plate and allowed to stir for 1 hour at about 105° C. To this were slowly added, 3.5 parts of a cyan dye as prepared in Example VII of U.S. Pat. No. 6,472,523. The resultant ink was stirred for 2.5 hours at 120° C. and then was filtered through a 5 μm stainless steel mesh and a 1 μm paper filter, respectively.

### Comparative Example 5

A cyan ink was prepared as follows. A molten and thoroughly mixed blend consisting of 30.0 parts polymethylene wax, 14.2 parts triamide wax, 14.2 parts KE-100 resin, 15.7 parts KEMAMIDE® S180, 2.2 parts urethane resin, 0.2 parts NAUGARD® 445 and 20 parts stearic acid (available from Sigma-Aldrich Co. LLC) were placed into a 600 milliliter beaker on top of a hot plate and allowed to stir for 1 hour at about 105° C. To this were slowly added, 3.5 parts of a cyan dye as prepared in Example VII of U.S. Pat. No. 6,472,523. The resultant ink was stirred for 2.5 hours at 120° C. and then was filtered through a 5 μm stainless steel mesh and a 1 μm paper filter, respectively.

### Comparative Example 6

A cyan ink was prepared as follows. A molten and thoroughly mixed blend consisting of 14.2 parts triamide wax, 14.2 parts KE-100 resin, 15.7 parts KEMAMIDE® S180, 2.2 parts urethane resin, 0.2 parts aromatic amine antioxidant NAUGARD® 445, and 50 parts stearic acid (available from Sigma-Aldrich Co. LLC) were placed into a 600 milliliter beaker on top of a hot plate and allowed to stir for 1 hour at about 105° C. To this were slowly added, 3.51 parts of a cyan dye as prepared in Example VII of U.S. Pat. No. 6,472,523. The resultant ink was stirred for 2.5 hours at 120° C. and then was filtered through a 5 μm stainless steel mesh and a 1 μm paper filter, respectively.

### Example 7

A cyan pigmented concentrate containing 15% pigment, 12% PEI 1, 3.75% Sunflo® SFD-B124 (a derivatized sulfonated copper phthalocyanine, available from Sun Chemical), and 69.25% KEMAMIDE® S-180 was processed in a HCPN-1/16 Nano Mill available from the Hockmeyer Equipment Corporation for 4 hours to form Compound A. To enable the making of a jettable ink, 12 grams of Compound A was placed into a pre-heated vessel with pre-heated stirrer bar and allowed to stir for 10 minutes. To this were slowly added, having already been melted and thoroughly mixed at 120° C., 52.34 parts (52.34 grams) of a polymethylene wax, 12.52 parts (12.52 grams) triamide wax, 12.52 parts (12.52 grams) KE-100 resin, 1.18 parts (1.18 grams) of a urethane resin, 9.13 parts (9.13 grams) KEMAMIDE® S180, and 0.31 parts (0.31 grams) NAUGARD® 445. The resultant ink was stirred for 2 hours at 120° C. then was filtered through a 5 μm stainless steel mesh.

### Example 8

A cyan concentrate containing 15% pigment, 12% PEI 1, 3.75% Sunflo® SFD-B124, and 69.25% KEMAMIDE® S-180 was processed in a HCPN-1/16 Nano Mill available from the Hockmeyer Equipment Corporation for 4 hours to form Compound A. Into a pre-heated vessel equipped with a stirrer bar that was allowed to equilibrate for 10 minutes at 120° C. were added 12 g of Compound A. To this were slowly added, having already been melted and thoroughly mixed at 120° C., 52.34 parts of a polymethylene wax, 12.0 parts triamide wax, 12.0 parts KE-100 resin, 1.18 parts of a urethane resin, 9.13 parts KEMAMIDE® S180, 0.31 parts NAUGARD® 445 and 1.04 parts stearic acid (available from Sigma-Aldrich Co. LLC). The resultant ink was stirred for 2 hours at 120° C. The resulted ink was filtered through a 5 μm stainless steel mesh.

### Example 9

To 12 grams of molten Compound A from Example 8 were slowly added, having already been melted and thoroughly mixed at 120° C., 52.34 parts of a biodegradable polyethylene wax, 12.0 parts triamide wax, 12.0 parts KE-100 resin, 1.18 parts of a urethane resin, 9.13 parts KEMAMIDE® S-180, 0.31 parts NAUGARD® 445 and 1.04 parts stearic acid (available from Sigma-Aldrich Co. LLC). The resultant ink was stirred for 2 hours at 120° C. The resulted ink was filtered through a 5 μm stainless steel mesh.

Ink Characterization Results.

Rheology.

The inks' rheologies were determined at 110° C. using a 50 millimeter cone and plate geometry on a RFS-III Rheometer, available from Rheometrics Corporation, now TA Instruments. The shear viscosities at 2 different shear rates were determined using a shear rate sweep from 1 to ˜250 s⁻¹. An appropriate target viscosity of the ink is approximately 10 centipoise at 110° C. The rheology results indicated that the dye-based cyan inks of the present disclosure, which incorporated no more than about 5 stearic acid, displayed Newtonian behavior as can be seen in Table 2. The Newtonian behavior can be indicated by the shear rate index which is indicated from the viscosities of any two suitably different shear rates such as 1 and 100 s⁻¹, such as was determined from a shear rate sweep test, for example. A convenient measure of the Newtonian quality of an ink can be expressed by the unit-less quotient of the viscosity at 1 s⁻¹ divided by the viscosity at 100 s⁻¹ where it is desirable, for example, that the shear rate index is less than 1.1, such that the shear rate index is less than 1.05, such that the shear rate index is 1.00 or approximately 1. The Example inks displayed such desirable Newtonian quality.

Image Characterization and Analysis.

Ink Printing.

Printed images were tested for robustness using the standard 3 finger solid ink gouge tester and the Duplo® paper folder performing a trifold on the paper. The printed image was a standard IQAF tape-fold-scratch print having a 525×450 dots per inch resolution and printed on XEROX® Color Xpressions Select paper using a PHASER® 8860 printer. The scratch and fold tests performed can be accomplished with any suitable paper such as XEROX® 4200 paper and the like.

Gouge Test.

The scratch resistances of 100% density filled test pattern prints were determined using an apparatus constructed such that it included a scratch/gouge finger with a curved tip at an angle of about 15° from vertical, fixed with a weight of 528 grams, and then drawn across the image of the print at a rate of approximately 13 mm/s. The scratch/gouge tip is similar to a lathe round nose cutting bit with a radius of curvature of approximately 12 millimeters. All inks were printed with the same print target and evaluated for scratch in the same manner. The area of the printed pixels of ink on the print occupying the print target, Area A, was held constant for the Examples and Comparative Examples.

Fold Test.

Fold and crease performance was measured by folding and creasing a solid print test area using a D-590 folding machine from Duplo Corporation and then examining this area for missing ink. All inks were printed with the same print target and evaluated for fold in the same manner. The area of the printed pixels of ink on the print occupying the print target, Area B, was held constant for the Examples and Comparative Examples.

Scanning Procedure to Quantify Scratch and Fold

Images were scanned using an Epson® 10000XL scanner with images manually placed on the scanner glass. All images were scanned in red, green, and blue at a resolution of 600 dots per inch. All image analysis was performed using National Instruments® Vision Assistant® 7.1 with the red color plane extracted such that the number of missing printed pixels resulting from the scratch test and fold test were reliably determined and as such corresponded to definite areas on the print defined as Areas C and D, respectively.

Results.

The level of scratch on a print was calculated as the ink area removed from the scratch/gouge finger divided by the fixed test pattern area of the print (containing a known and definite amount of printed pixels of ink on the paper) multiplied by 100 percent.

% (area removed by scratch)=(Area C/Area A)*100

The level of fold on a print was calculated as the ink area removed from the fold test divided by the fixed test pattern area of the print (containing a known and definite amount of printed pixels of ink on the paper) multiplied by 100 percent.

% (area removed by fold)=(Area D/Area B)*100

Replicate runs were performed for both scratch and fold tests where the means of the two results from each test for each ink were determined and summarized in Table 2.

The results in Table 2 show that the present dye-based solid inks including a small amount of stearic acid, 5% or less than about 5% by weight, possess significantly improved performance with respect to scratch and fold resistance while preserving the desired characteristics of current dye-based solid inks including Newtonian rheology, good filtration properties, good thermal stability, ink jetting robustness, etc. The images produced were free of drop-out concerns, further providing inks having the desired thermal properties of the previous dye-based solid inks.

Higher loadings of stearic acid to dye-based phase change ink, in embodiments, at 10 percent or higher by weight stearic acid, were not jettable and exhibited transfix problems. Additional printing studies were also performed which included varying the transfix drum temperature but did not result in achieving a good transfix or even a reasonable transfix for dye-based phase change inks comprising 10 or more percent by weight stearic acid.

TABLE 2

| | | | | | | | Jettable | | |
|---|---|---|---|---|---|---|---|---|---|
| | | | | Viscosity | Viscosity | | in | | Area (%) |
| | Non | | wt % | at 1 s⁻¹ at | at 100 s⁻¹ | Shear | Xerox | Area (%) | removed |
| | Polar | | Stearic | 110° C. | at 110° C. | Rate | Phaser | removed | by |
| Example | wax | Colorant | Acid | (cP) | (cP) | Index | 8860 | by Fold | Scratch |
| Comparative | Wax A | Cyan | 0 | 10.8 | 10.8 | 1.00 | yes | 2.05 | 4.66 |
| Example 1 | | dye | | | | | | | |
| Example 2 | Wax A | Cyan | 4.8 | 10.4 | 9.5 | 1.09 | yes | 0.98 | 0.79 |
| | | dye | | | | | | | |
| Example 3 | Wax B | Cyan | 4.8 | 11.6 | 11.0 | 1.05 | yes | 0.42 | 3.62 |
| | | dye | | | | | | | |
| Example 4 | Wax A | Cyan | 10 | — | — | — | no | — | — |
| | | dye | | | | | | | |
| Example 5 | Wax A | Cyan | 20 | — | — | — | no | — | — |
| | | dye | | | | | | | |
| Example 6 | Wax A | Cyan | 50 | — | — | — | no | — | — |
| | | dye | | | | | | | |
| Comparative | Wax A | Cyan | 0 | 11.6 | 11.2 | 1.04 | yes | 1.98 | 5.21 |
| Example 7 | | pigment | | | | | | | |
| Example 8 | Wax A | Cyan | 1.04 | 11.3 | 11.0 | 1.03 | yes | 0.57 | 2.52 |
| | | pigment | | | | | | | |
| Example 9 | Wax B | Cyan | 1.04 | — | — | — | yes | 0.10 | 3.44 |
| | | pigment | | | | | | | |

The addition of approximately 1% stearic acid in pigmented phase change inks, Example 8 and 9, resulted in a substantial decrease in fold and scratch compared to the pigmented phase change ink without stearic acid, Comparative Example 7.

The prints obtained from the Example inks, except in Examples 3, 4 and 5, displayed excellent print quality.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A phase change ink composition comprising:
a carrier;
a colorant; and
an acidic wax which is present in an amount of 0.1 to less than 6 percent by weight based on the total weight of the phase change ink composition.

2. The phase change ink composition of claim 1, wherein the acidic wax is selected from the group consisting of capryilic acid, capric acid, lauric acid, palmitic acid, myristic acid, stearic acid, eicosanoic acid, behenic acid, lignoceric acid, cerotic acid, montanic acid, melissic acid and mixtures and combinations thereof.

3. The phase change ink composition of claim 1, wherein the acidic wax is stearic acid.

4. The phase change ink composition of claim 1, wherein the carrier is a polyalkylene wax.

5. The phase change ink composition of claim 1, wherein the carrier is a polymethylene wax, a polyethylene wax, or a mixture or combination thereof.

6. The phase change ink composition of claim 1, wherein the carrier is a biodegradable wax.

7. The phase change ink composition of claim 1, wherein the carrier is a biodegradable polyethylene wax.

8. The phase change ink composition of claim 1, wherein the carrier is present in the phase change ink composition in an amount of from about 25 percent to about 65 percent by weight based on the total weight of the phase change ink composition.

9. The phase change ink composition of claim 1, wherein the colorant is a dye.

10. The phase change ink composition of claim 1, wherein the colorant is a pigment.

11. The phase change ink composition of claim 1, wherein the acidic wax is present in an amount of 0.1 to less than 5 percent by weight based on the total weight of the phase change ink composition.

12. The phase change ink composition of claim 1, further comprising:
(a) stearyl stearamide, (b) triamide, or (c) mixtures thereof.

13. The phase change ink composition of claim 1, further comprising:
a mixture of one or more amides and one or more isocyanate-derived materials.

14. The phase change ink composition of claim 1, wherein the phase change ink composition has a jetting temperature of from about 100° C. to about 130° C.

15. The phase change ink composition of claim 1, wherein the phase change ink composition has a viscosity of about 9 to about 12 centipoise at 110° C.

16. The phase change ink composition of claim 1, wherein the phase change ink composition has a viscosity of about 10 centipoise at 110° C.

17. The phase change ink composition of claim 1,
wherein an image printed with the phase change ink composition provides a fold result of less than about 1% removed by fold;
wherein the fold result is an ink area removed by a fold test divided by a fixed test pattern area of the print (containing a known and definite amount of printed pixels of ink on the paper) multiplied by 100 percent.

18. The phase change ink composition of claim 1, wherein an image printed with the phase change ink composition provides a scratch result of less than about 4% removed by scratch;
wherein the scratch result is an ink area removed from the scratch/gouge finger divided by the fixed test pattern area of the print (containing a known and definite amount of printed pixels of ink on the paper) multiplied by 100 percent.

19. A method comprising:
incorporating into an ink jet printing apparatus a phase change ink composition comprising a carrier; a colorant; and an acidic wax which is present in an amount of 0.1 to less than about 6 percent by weight based on the total weight of the phase change ink composition;
melting the ink composition; and
causing droplets of the melted ink to be ejected in an imagewise pattern onto a substrate.

20. An ink jet printer stick or pellet containing a phase change ink composition comprising a carrier; a colorant; and an acidic wax which is present in an amount of 0.1 to less than about 6 percent by weight based on the total weight of the phase change ink composition.
